(19) United States
(12) Patent Application Publication
(10) Pub. No.: US 2007/0045081 A1
(43) Pub. Date: Mar. 1, 2007

(54) Currency sorting/cleaning case and currency sorting case

(76) Inventor: Toshiaki Sugawara, Yamagata (JP)

Correspondence Address: CANTOR COLBURN, LLP, 55 GRIFFIN ROAD SOUTH, BLOOMFIELD, CT, 06002, US

(21) Appl. No.: 11/505,579

(22) Filed: Aug. 17, 2006

Related U.S. Application Data
(63) Continuation of application No. PCT/JP05/02436, filed on Feb. 17, 2005.

(30) Foreign Application Priority Data
Feb. 18, 2004 (JP) JP 2004-041313
Feb. 18, 2004 (JP) JP 2004-041320
Oct. 5, 2004 (JP) JP 2004-292065

(51) Int. Cl. G07F 1/04

(52) U.S. Cl. 194/349

(57) ABSTRACT

It is aimed at providing: a currency sorting/cleaning case configured to simultaneously attain cleaning and sorting/receiving of currencies, and configured to facilitate count and extraction of cleaned currencies; and a currency sorting case configured to provide only a sorting/receiving/counting/extracting function of currencies in a rapid and easy manner.

The currency sorting/cleaning case of the present invention receives therein: a coin receipt casing 6 for receiving coins therein; a paper money receipt casing 11 for receiving paper moneys therein; a coin-oriented detergent reservoir 7; and a paper money-oriented detergent reservoir 14. Installed within the coin receipt casing 6 are two-staged upper and lower coin sort slots 4, 3 perpendicularly to a long axis direction of the coin receipt casing 6, and it is configured such that coins are charged through an opening/closing type coin charge opening 9, and thereafter the currency sorting/cleaning case 101 is held substantially vertically and shaken horizontally to sort the charged coins.

### TECHNICAL FIELD

The present invention relates to a currency (including coins and paper moneys) sorting/cleaning case capable of sorting, receiving, and extracting large and small currencies while cleaning the currencies, and a currency sorting case capable of sorting, receiving, and extracting large and small currencies where the currencies are already in a clean state.

### BACKGROUND ART

In conventional currency cases, i.e., wallets, coin bags and the like each serving as a tool for receiving currencies therein and for counting and extracting currencies therefrom upon payment for a purchased article, there is not provided a function for cleaning currencies and for promptly and easily sorting and receiving large and small currencies therein. Note that the term “clean (or cleaning)” in the present invention means an operation for conducting wash or sterilization by various detergents, and the term “detergent” means a single substance or a complex composition substance in a liquid, solid, or gas form having a cleaning ability or sterilizing ability.

It is already well-known to sort coins by outer diameter, by means of sort slots. For example, Japanese Utility Model Gazette No. S62-13170 describes a sorter provided with sort slots which have height dimensions and width dimensions slightly larger than those of coins, respectively, and which are provided along a slope in an order from small slot to large slot, in a manner to move down coins along the slope to thereby sort them.

Further, Japanese Registered Utility Model No. 3001110 describes a sorter provided with sort slots each having at least one lateral dimension smaller than an outer diameter of a corresponding coin, and the sort slots are provided along a slope in an order from small one to large one, in a manner to move down coins along the slope to thereby sort them.

Moreover, Japanese Utility Model Publication No. H02-105725 describes to disinfect currencies, i.e., paper moneys and coins, by filling an interior of a wallet with a disinfection gas.

However, according to the above-mentioned related art, contamination of circulated currencies in a currency case such as a wallet, coin bag, or the like has been likely to infect fingers of a person to cause propagation of bacteria infection, and large and small coins have been received in the currency case in a mixed state to make it difficult to count and extract the coins.

Further, in the mechanism of the coin sorter in the Japanese Utility Model Gazette No. S62-13170 or Japanese Registered Utility Model No. 3001110, there are no regions for sorting and receiving coins, and the coin sorter is made larger than a space region of a typical coin case depending on the arrangement of sort slots aligned along the slope and on the shape conditions of the sort slots, thereby failing to use the coin sorter as a coin case.

Furthermore, in the currency handling method described in the Japanese Utility Model Publication No. H02-105725, the disinfection gas is always flowed out of the wallet to possibly cause such a negative effect that the odor of the disinfectant and the disinfecting effect unintentionally affect the ambient outside the wallet, and there are provided no sorting and arranging functions which contribute to count and extraction of currencies.

It is therefore an object of the present invention to provide: a currency sorting/cleaning case configured to simultaneously attain cleaning and sorting/receiving of currencies without leakage of a currency oriented detergent to the exterior, and configured to facilitate count and extraction of cleaned currencies; and a currency sorting case configured to provide only a sorting/receiving/counting/extracting function of currencies in a rapid and easy manner, in a situation where the currencies are already in a clean state, such as when the currency sorting/cleaning cases have been widely used in such an extent to keep cleanliness of currencies.

### SUMMARY OF INVENTION

To solve the above problem, the present invention provides a first configuration residing in a currency sorting/cleaning case, comprising: a coin receipt casing configured to define a space for receiving coins therein; a coin movement floor constituting a part of the coin receipt casing to cause the coins to move horizontally; a coin sort slot provided within the coin receipt casing and having a slot in a predetermined size to sort coins; a detergent reservoir provided adjacently to the coin receipt casing, the detergent reservoir being configured to reserve therein a detergent for cleaning coins; a detergent hole provided at a boundary between the coin receipt casing and the detergent reservoir such that the detergent comes out of the detergent reservoir into the coin receipt casing and comes back therefrom into the detergent reservoir; an opening/closing type charge opening provided at a part of the coin receipt casing and configured to charge coins through the opening/closing type charge opening itself; an opening/closing lid provided at a part of the coin receipt casing, the opening/closing lid being configured to cause coins to be taken out of the coin receipt casing; and a seal portion configured to prevent the detergent from leaking through a gap between the opening/closing lid and the casing.

The second configuration resides in the currency sorting/cleaning case, wherein the opening/closing lid is transparent or translucent, and wherein the currency sorting case further comprises: an anchor configured to closely contact and fix the opening/closing lid with and to the seal portion; a paper money receipt casing provided to be coupled to the coin receipt casing, the paper money receipt casing being configured to receive paper moneys therein; a paper money arrangement floor provided within the paper money receipt casing, the paper money arrangement floor being configured to arrange paper moneys with height differences therebetween in a stepwise manner; an additional detergent reservoir provided adjacently to the paper money receipt casing, the additional detergent reservoir being configured to reserve an additional detergent therein; an additional opening/closing lid provided at a part of the paper money receipt casing, the transparent or translucent additional opening/closing lid being configured to allow charge and withdrawal of paper moneys therethrough; a transparent or translucent additional seal portion configured to prevent leakage of the additional detergent from a gap between the additional opening/closing lid and the paper money receipt casing; and an additional anchor configured to closely contact and fix the additional opening/closing lid with and to the additional seal portion.

The third configuration resides in the currency sorting case, wherein the coin movement floor is a flat and smooth plate forming a bottom surface of the coin receipt casing.

The fourth configuration resides in the currency sorting case, wherein the detergent hole is provided on the coin movement floor; wherein the detergent reservoir is arranged parallel to the bottom surface of the coin receipt casing; wherein the detergent flows from the detergent reservoir through the detergent hole into the coin receipt casing; and wherein the detergent is collected back from the coin receipt casing through the detergent hole into the detergent reservoir and received therein.

The fifth configuration resides in the currency sorting case, wherein the slot provided in the coin sort slot is in a rectangular shape or in a shape containing the rectangular shape, or is in an elliptical shape or in a shape containing the elliptical shape.

The sixth configuration resides in the currency sorting case, wherein the slot of the coin sort slot has a shape formed to allow passage therethrough of a coin in a predetermined size and a coin smaller than it, and to prevent passage therethrough of a coin larger than the coin in the predetermined size, and wherein assuming that the coin in the predetermined size has a diameter Aᵢ, a coin which is next larger than the coin in the predetermined size has a diameter Aᵢ₊₁, and a play length _{α} is defined such that 0<_{α}<0.45(Aᵢ₊₁−Aᵢ), the shape of the slot of the coin sort slot is a rectangular shape having a long side length equal to Aᵢ+2_{α} and a diagonal line length smaller than Aᵢ+2_{α}, or an elliptical shape having a long axis length equal to Aᵢ+2_{α}.

The seventh configuration resides in the currency sorting case, wherein the coin sort slot has a peripheral frame partially contacted with the coin movement floor; wherein the coin sort slot comprises multiple coin sort slots installed in a decreasing order of sort slot size when viewed from the opening/closing type charge opening; and wherein the coin movement floor and frames of the coin sort slots cooperatively define sort receipt regions for receiving therein sorted coins, respectively.

The eighth configuration resides in the currency sorting case, wherein the paper money arrangement floor is arranged at a predetermined inclination angle relative to mutually parallel bottom surface and upper surface of the paper money receipt casing, in a manner that only an upper side of the paper money arrangement floor is contacted with the bottom surface and that the paper money arrangement floor is arranged perpendicularly to sidewalls of the paper money receipt casing which are perpendicular to the bottom surface and the upper surface.

The ninth configuration resides in the currency sorting case, wherein the additional detergent reservoir is arranged adjacently to a wall surface within the paper money receipt casing or to the paper money arrangement floor; and wherein the additional detergent is flowed into the paper money receipt casing through an additional detergent hole provided at the wall surface of the paper money receipt casing and/or the paper money arrangement floor.

The tenth configuration resides in the currency sorting case, wherein the detergent and the additional detergent are each liquid, solid, and/or gas having a currency cleaning effect.

The eleventh configuration resides in the currency sorting case, wherein the coin receipt casing and the paper money receipt casing have sidewalls formed with taper-type female ventilation holes, respectively; wherein the coin receipt casing and the paper money receipt casing are equipped with at least one or more of the anchor and the additional anchor, respectively; and wherein the anchor and the additional anchor are provided with pins, which have tip ends to be closely contacted with the taper-type female ventilation holes, respectively, and which each close the taper-type female ventilation hole when the opening/closing lid or the additional opening/closing lid is closed and each opens the taper-type female ventilation hole when the opening/closing lid or the additional opening/closing lid is opened.

The twelfth configuration resides in the currency sorting/cleaning case, wherein,

assuming that diameters of a group of coins circulated within a single economic bloc having “n” kinds of diameters A₁, A₂, A₃, . . . Aᵢ, Aᵢ₊₁, . . . Aₙ (mm) are defined as actual outer diameters, respectively,

that the actual outer diameters are in an order of:

A₁<A₂<A₃< . . . <Aᵢ<A₁₊₁< . . . <Aₙ; and

that outer diameters, which are obtained by adding a play length _{α} mm to both ends of the actual outer diameters in rectilinear directions thereof, are defined as practical outer diameters a₁, a₂, a₃, . . . aᵢ, aᵢ₊₁, . . . aₙ (mm), respectively, i.e.,
a₁=A₁+2_{α}
a₂=A₂+2_{α}
aᵢ=Aᵢ+2_{α}
aᵢ₊₁=Aᵢ₊₁+2_{α}

. . .

. . .
aₙ=Aₙ+2_{α};

where “n” is a natural number, and “i” is an integer from 1 to “n”;

the rectangle and/or ellipse constituting the shape of the coin sort slot is a rectangle and/or an ellipse,

in which the rectangle has the play length _{α}, long axis X, and diagonal line Y, represented by:
0<_{α}<0.45(Aᵢ₊₁−Aᵢ),

X=aᵢ, and aᵢ<Y<Aᵢ₊₁, respectively; and

in which the ellipse has the long axis X represented by:

X=aᵢ.

### EFFECT OF THE INVENTION

According to the sorted reception of coins by the present invention, there are particularly solved difficulties in counting the number of stocked coins and in counting and extracting the coins caused due to 1-yen aluminum coins which are increased in number after imposition of consumption tax; and according to the arranged receipt or arranged and sorted reception of paper moneys, there is quickened counting of stocked paper moneys and counting and extracting thereof, while simultaneously preventing contamination of circulated currencies; so that fingertips of a person to be contacted with the currencies are kept clean, and this cleanliness and that of currencies are spread all over our society to bring about a remarkable effect contributing to hygiene of human bodies and of the environment.

This encourages development of such a new manner for environmental hygiene that “cleanliness is handed over from person to person, by his/her fingertips and his/her currencies”.

According to the case of the present invention, coins, which have been contaminated media, are cleaned, sorted, counted and extracted in an antibacterially coated state, and brought into coins serving as hygienic media which are to hand over an antibacterial ability from finger to finger and from person to person. As a result, there is intensively and continuously sterilized a contamination infecting path through “finger”-“currency”-“finger”-“mouth” to thereby newly establish a widened and densed cleanliness network in the life environment closest to us, thereby enabling contribution to substantial and effective opposition against occurrence of new bacteria and virus, and overwhelming influences thereof.

### BRIEF DESCRIPTION OF THE DRAWINGS

FIG. 1 is a plan view, elevational view, and side view of one embodiment of the present invention.

FIG. 2 is a perspective view of one embodiment of an anchor of a casing of the present invention.

FIG. 3 is Table 1 of one embodiment of the present invention showing shapes and dimensions of a group of coins circulated in Japan and coin sort slots, and practical ranges and examples of the shapes and dimensions.

FIG. 4 is Table 2 of one embodiment of the present invention showing shapes and dimensions of a group of coins circulated in the United States and coin sort slots, and practical ranges and examples of the shapes and dimensions.

FIG. 5 is Table 3 of one embodiment of the present invention showing shapes and dimensions of groups of Euro coins circulated in EU bloc and coin sort slots, and practical ranges and examples of the shapes and dimensions.

FIG. 6 is Table 4 of one embodiment of the present invention showing shapes and dimensions of a group of coins circulated in the People's Republic of China and coin sort slots, and practical ranges and examples of the shapes and dimensions.

FIG. 7 is Table 5 of one embodiment of the present invention showing shapes and dimensions of a group of coins circulated in Hong Kong bloc and coin sort slots, and practical ranges and examples of the shapes and dimensions.

FIG. 8 is Table 6 of one embodiment of the present invention showing shapes and dimensions of a group of coins circulated in the Republic of Korea and coin sort slots, and practical ranges and examples of the shapes and dimensions.

FIG. 9 is Table 7 of one embodiment of the present invention showing shapes and dimensions of a group of coins circulated in the Commonwealth of Australia and coin sort slots, and practical ranges and examples of the shapes and dimensions.

FIG. 10 is Table 8 of one embodiment of the present invention showing shapes and dimensions of a group of coins circulated in India and coin sort slots, and practical ranges and examples of the shapes and dimensions.

FIG. 11 is a perspective view of an additional embodiment of the present invention.

FIG. 12 is a view of a circular sort slot of the present invention embracing an inscribed rectangle of the rectangular sort slot.

FIG. 13 is a view of an arcuate sort slot of the present invention embracing a rectangle of the rectangular sort slot by sharing four apexes of the rectangle.

FIG. 14 is a front view of an adjustable rectangular sort slot of the present invention.

FIG. 15 is a plan view of the adjustable rectangular sort slot of the present invention.

FIG. 16 is a right side view of the adjustable rectangular sort slot of the present invention.

FIG. 17 is a coin sort case of the present invention.

### EXPLANATION OF REFERENCE NUMERALS

1 anchor for coin takeout transparent opening/closing lid
2 coin takeout transparent opening/closing lid
3 lower coin sort slot
4 upper coin sort slot
5 detergent leakage prevention seal portion
6 coin receipt casing
7 coin-oriented detergent reservoir
8 coin-oriented detergent hole
9 opening/closing coin charge opening
10 coin movement floor
11 paper money receipt casing
12 paper money arrangement floor
13 twofold paper money
14 paper money-oriented detergent liquid reservoir
15 paper money-oriented hole
16 detergent leakage prevention seal portion
17 anchor for paper money receipt/takeout transparent opening/closing lid
18 paper money receipt/takeout transparent opening/closing lid
19 coin
20 rotational shaft for paper money receipt/takeout transparent opening/closing lid
21 rotational shaft for coin takeout transparent opening/closing lid
22 anchor pin rotation knob
23 anchor pin
24 anchor pin fixture
25 tapered ventilation hole
31 detergent reservoir
32 exterior casing circumference
33 detergent hole
34 coin sort slot
35 rotation/fixture shaft for coin takeout transparent opening/closing lid
36 detergent leakage prevention seal
37 coin takeout transparent opening/closing lid
38 interior casing
39 50-yen coin
40 1-yen coin
41 500-yen coin
42 100-yen coin
43 5-yen coin
44 10-yen coin
45 opening/closing type coin charge opening
46 coin movement floor
51 circular sort slot
52 rectangle of rectangular sort slot
53 arcuate side based on rectangular sort slot
61 adjustable rectangular sort slot
62 long side shift plate
63 short side shift plate
64 long side adjustment screw
65 long side shift plate guide
66 short side adjustment screw
67 short side adjustment screw guide
68 long side length measurement window portion
69 short side length measurement window portion
71 casing bottom
72 coin takeout transparent opening/closing lid
73 lower coin sort slot
74 upper coin sort slot
75 opening/closing type coin charge opening
76 casing upper portion
77 coin movement floor
101, 102 currency sorting/cleaning case
103 coin sort case

### BEST MODE FOR CARRYING OUT THE INVENTION

There will be explained preferred embodiments of the present invention with reference to the drawings.

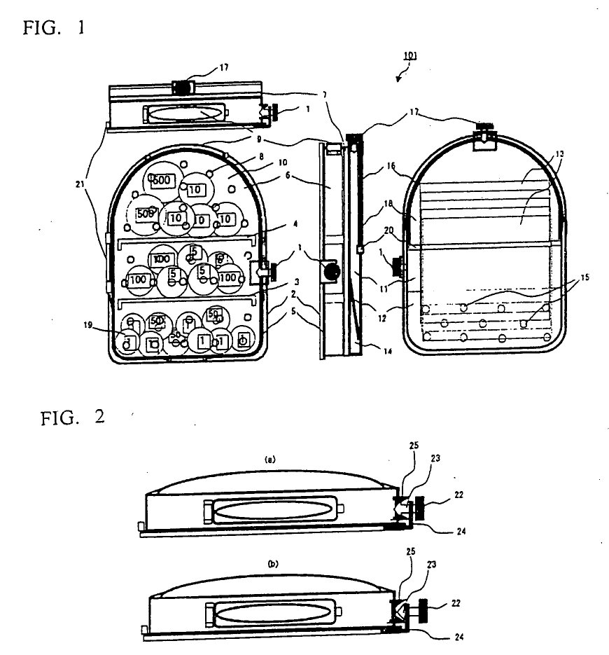

FIG. 1 is a view showing one embodiment of a currency sorting/cleaning case of the present invention.

The currency sorting/cleaning case 101 is in such a size that the same can be received in a palm, and exemplarily has a shape combining a rectangular parallelepiped with a half-column here. The currency sorting/cleaning case 101 has a top portion provided with an opening/closing type coin charge opening 9, and internally contains a coin receipt casing 6 for receiving coins therein, a paper money receipt casing 11 for receiving paper moneys therein, a coin-oriented detergent reservoir 7, and a paper money-oriented detergent reservoir 14.

The coin receipt casing 6 is provided therein with two-staged upper and lower coin sort slots 4, 3 perpendicularly to a longitudinal axis of the coin receipt casing 6, and is configured to sort charged coins such that, after the coins have been charged into the coin receipt casing through the opening/closing type coin charge opening 9, the currency sorting/cleaning case 101 is held in a substantially vertical posture and then shaken horizontally. Namely, charged groups of large, middle, and small coins are moved on the coin movement floor 10 parallel thereto by the gravity and the horizontal shaking, and upon contact of edges of the coins with upper coin sort slots 4, large coins close the slots and are kept there, and middle and small coins are inserted and allowed to pass through the upper coin sort slots 4, respectively, thereby causing sortation. Further, the passed coins are brought to the lower coin sort slots 3, and middle coins are kept blocked there while small coins are allowed to pass therethrough, thereby eventually achieving sortation of large, middle, and small coins.

Simultaneously, there is caused a predetermined detergent from the coin-oriented detergent reservoir 7 provided at a reverse side of the coin movement floor 10, to flow through detergent holes 8 formed at the coin movement floor 10 into the casing 6, and to contact with moving coins to clean them. The predetermined detergent is sealed by virtue of a sealing function provided by a detergent leakage prevention seal portion 5 positioned in a gap between the coin takeout transparent opening/closing lid 2 and coin receipt casing 6, and an anchor 1 for the coin takeout transparent opening/closing lid, so that the predetermined detergent is not leaked out and is collected back into the coin-oriented detergent reservoir 7 through the coin-oriented detergent holes 8 by horizontally positioning the coin receipt casing 6.

Note that the anchor 1 for the coin takeout transparent opening/closing lid has a structure as shown in FIG. 2, so as to realize the sealing function. The coin receipt casing 6 and the paper money receipt casing 11 have sidewalls provided with tapered ventilation holes 25, respectively. Further, the anchor 1 for the coin takeout transparent opening/closing lid and an anchor 17 for a paper money receipt/takeout transparent opening/closing lid are provided with anchor pins 23 having tip ends to be closely contacted with the tapered ventilation holes 25, respectively.

In the state of FIG. 2(a) where the coin takeout transparent opening/closing lid 2 is closed, the anchor pin 23 attached to an associated anchor pin rotation knob 22 closes the associated tapered ventilation hole 25 provided at the sidewall of the currency sorting/cleaning case 101, thereby realizing the above-mentioned sealing function. The anchor pin 23 is supported by an anchor pin fixture as shown in FIG. 2(b), and the anchor pin 23 is released from the associated tapered ventilation hole 25 when the coin takeout transparent opening/closing lid 2 is to be opened.

The sorted and cleaned state of coins within the coin receipt casing 6 is observed through the coin takeout transparent opening/closing lid 2 configured to be transparent, the anchor 1 for the coin takeout transparent opening/closing lid is released in a horizontal state where the predetermined detergent has been collected back, the coin takeout transparent opening/closing lid 2 is opened, and the sorted and cleaned coins are counted and extracted. Used as the predetermined detergent is a 30% ethanol-water solution, at a volume of about 90% of that of the coin-oriented detergent reservoir 7.

Meanwhile, installed within the paper money receipt casing 11 contacted with the coin-oriented detergent reservoir 7, is a paper money arrangement floor 12, and the paper money arrangement floor 12 has such a structure that twofold paper moneys 13 are arranged with height differences therebetween in a stepwise manner by virtue of inclination of the paper money arrangement floor 12, thereby enabling paper moneys to be sorted and received and rapidly counted and extracted.

Further, there is caused an additional predetermined detergent from the paper money-oriented detergent reservoir 14 installed at the paper money arrangement floor 12, to flow through detergent holes 15 into the paper money receipt casing 11 as a sublimated gas, and is spread and filled in the paper money receipt casing 11 without leakage to the exterior, by virtue of the sealing function obtained by the detergent leakage prevention seal portion 16 and the anchor 17 for the paper money receipt/takeout transparent opening/closing lid, thereby sterilizing the twofold paper moneys 13.

The twofold paper moneys 13 in the sorted and sterilized state are counted and extracted, by releasing the anchor 17 for the paper money receipt/takeout transparent opening/closing lid, and by opening the paper money receipt/takeout transparent opening/closing lid 18.

Usable as the additional predetermined detergent is a 1/10 dilution of parachlorometaxylenol.

There will be explained detailed structures of the lower and upper coin sort slots 3, 4 to be used in this embodiment. In the following, it is assumed that the lower and upper coin sort slots 3, 4 are each rectangle in cross-sectional shape, each have a long side of a length X and a diagonal line of a length Y, and coins existing in N kinds have outer diameters Aᵢ (hereinafter called “actual outer diameters”) (i=1 to N), respectively. Note that the coin of i=1 has the minimum outer diameter, outer diameters are successively increased, and the coin of i=N has the maximum outer diameter. Further, to cause coins to be easily and rapidly passed through sort slots, there shall be defined a practical outer diameter aᵢ which is obtained by adding play lengths 2_{α} to the actual outer diameter Aᵢ of the i-th coin. Namely, aᵢ=Aᵢ+2_{α}.

The lower coin sort slots 3 or upper coin sort slots 4 are capable of sorting coins equal to or smaller than an i-th coin from those equal to or larger than an (i+1)-th coin, by setting the slot to have a cross section having the long side length X which is equal to the practical outer diameter aᵢ of the i-th coin, and the diagonal line length Y which is larger than the practical outer diameter aᵢ of the i-th coin and smaller than the actual outer diameter Aᵢ₊₁ of the (i+1)-th coin. Namely, the sort slots each allow passage therethrough of coins equal to or smaller than the i-th coin and block coins equal to or larger than the (i+1)-th coin.

According to the present invention, it is required that the long axis X of the sort slot in the rectangular shape is set to be equal to the practical outer diameter aᵢ of the coin, and the diagonal line Y is always set to be smaller than the actual outer diameter Aᵢ₊₁ so as to sort the i-th coin from the (i+1)-th coin. Namely, X=aᵢ and aᵢ<Y<Aᵢ₊₁.

As values of play length _{α} are increased, i.e., as X and Y values of the sort slots approach the Aᵢ₊₁, the coin “i” is allowed to pass the sort slot “i” more rapidly and easily. However, when the _{α} is increased and the long axis X and the diagonal line Y of the sort slot become equal to the actual outer diameter Aᵢ₊₁ of the coin “i+1”, the coin “i+1” is brought to pass the sort slot “i”, so that both coins can not be sorted from each other.

In order to most rapidly and accurately attain sortation of both coins from each other, there is required a presence of a value D as a minimum value in a finite and possible manner, which is smaller than a difference between the long axis X of the sort slot and the actual outer diameter Aᵢ₊₁ of the (i+1)-th coin. Similarly, there is required a presence of a value E as a minimum value in a finite and possible manner, which is smaller than a difference between the diagonal line Y and the actual outer diameter Aᵢ₊₁ of the (i+1)-th coin. Namely,
0<D<{[Aᵢ₊₁]−X}={[Aᵢ₊₁]−[Aᵢ+2_{α}]} (1)
0<E<{[Aᵢ₊₁]−Y}={[Aᵢ₊₁]−[Aᵢ+2_{α}]/cos δᵢ} (2)

wherein δᵢ represents an angle formed between X and Y.

The finite and possibly minimum value E, which is machinable, shall be now fixed at 0.1 mm. Namely, Y is fixed such that Y=[Aᵢ₊₁]−0.1 mm. The angle δ is movable. When it is assumed that 0<r<1 and that the other finite and possibly minimum value D is represented as D=r{[Aᵢ₊₁]−[Aᵢ]} while defining the “r” as a play coefficient, the machining precision of the rectangle is made severer as the “r” becomes smaller. From the formula (1),
r{[Aᵢ₋₁]−[Aᵢ]}<{[Aᵢ₊₁]−Aᵢ−2_{α}}

and,

the play length _{α} has an allowable range represented by the play coefficient “r”, as follows:
0<_{α}<0.5(1−r){[Aᵢ₊₁]−[Aᵢ]}

When the machining precision and material of a coin sort slot are derived from a precision superhard material (such as WC—Ti—Cr based material or the like), it is possible to provide the machining precision with the play coefficient “r”≧0.10, and the play length is represented as follows:
_{α}≦0.45{[Aᵢ₊₁]−[Aᵢ]}
(For example, in case of sortation of a 50-yen coin of Aᵢ=21 mm from a 5-yen coin of Aᵢ₊₁=22 mm, the value D for the long axis X is 0.10 mm because [Aᵢ₊₁]−[Aᵢ]=1 mm and thus X=21.9 mm, so that the Y value in this situation should be 21.9 mm<Y<22.0 mm so as to form a rectangle.)

When the machining precision and a material of a coin sort slot are derived from cutting and a special alloy (such as Al—Zn—Mg based alloy or the like), respectively, or derived from a precision superhard material (such as WC—Co based alloy or the like) derived from a powder metallurgical method, it is possible to provide the machining precision with “r”≧0.2, and:
_{α}≦0.40{[Aᵢ₊₁]−[Aᵢ]}
(In case of sortation of a 50-yen coin from a 5-yen coin, there is formed a rectangle of X=21.8 mm and Y=21.9 mm when the D value is 0.2 mm.)

When the machining precision and a material of a coin sort slot are derived from ordinary extrusion and a general-purpose alloy (such as Al alloy or the like) or a special resin (engineering resin such as PC), respectively, it is possible to provide the machining precision with “r”≧0.4, and:
_{α}≦0.30{[Aᵢ₊₁]−[Aᵢ]}
(In case of sortation of a 50-yen coin from a 5-yen coin, there is formed a rectangle of X=21.6 mm and Y=21.9 mm when the D value is 0.4 mm.)

When the machining precision and a material of a coin sort slot are derived from ordinary extrusion and a general-purpose hard resin (such as ABS), respectively, it is possible to provide the machining precision with “r”≧0.60, and:
_{α}≦0.20{[Aᵢ₊₁]−[Aᵢ]}
(In case of sortation of a 50-yen coin from a 5-yen coin, there is formed a rectangle of X=21.40 mm and Y=21.9 mm when the D value is 0.60 mm.)

When the machining precision and a material of a coin sort slot are derived from ordinary extrusion and a general-purpose resin (such as PE, PP, or the like), respectively, it is possible to provide the machining precision with “r”≧0.80, and:
_{α}≦0.10{[Aᵢ₊₁]−[Aᵢ]}
(In case of sortation of a 50-yen coin from a 5-yen coin, there is formed a rectangle of X=21.20 mm and Y=21.9 mm when the D value is 0.80 mm.)

The machining precision and material for each sort slot in the embodiment of the present invention are determined by seeking for an economical efficiency to an extent that the sorting performance (speed and accuracy) is not obstructed; such that, in case of the sortation example of a 50-yen coin from a 5-yen coin, when the play coefficient “r” is made smaller than 0.20, the play length _{α} is made larger than 0.4 mm, so that passage of a 50-yen coin through a sort slot is made extremely rapid and easy to improve a sorting performance, but there are demanded a machining precision finer than 0.20 mm and a shape retention to thereby necessitate precision machining and expensive superhard materials, thereby deteriorating economical efficiency due to an extremely increased production cost.

In turn, also in case of the sortation example of a 50-yen coin from a 5-yen coin, when the play coefficient “r” is made larger than 0.95, the machining precision is allowed to be about 0.95 mm, so that general-purpose machining processes and materials can be used to decrease a production cost; however, the play length _{α} is then made smaller than 0.05 mm such that the passage speed of the coin through the sort slot is made slower to thereby deteriorate the sorting performance. Further, the passage resistance through the sort slot is increased, such that the shape of the sort slot is damaged when the same is made of an inexpensive and soft material, thereby leading to a deteriorated sorting performance.

Thus, the preferable embodiment resides in that the play coefficient “r” is 0.1<r<1.0, more preferably 0.1<r<0.8, and this is represented by the play length _{α} such that 0<_{α}<0.45{[Aᵢ₊₁]−[Aᵢ]}, more preferably 0.1 {[Aᵢ₊₁]−[Aᵢ]}<_{α}<0.45{[Aᵢ₊₁]−[Aᵢ]}. Only, the long axis X of the sort slot is such that X=aᵢ=[Aᵢ]+2_{α}, and the diagonal line Y is such that aᵢ<Y<[Aᵢ₊₁] in a manner that the Y value may be a fixed value or variable value within this range.

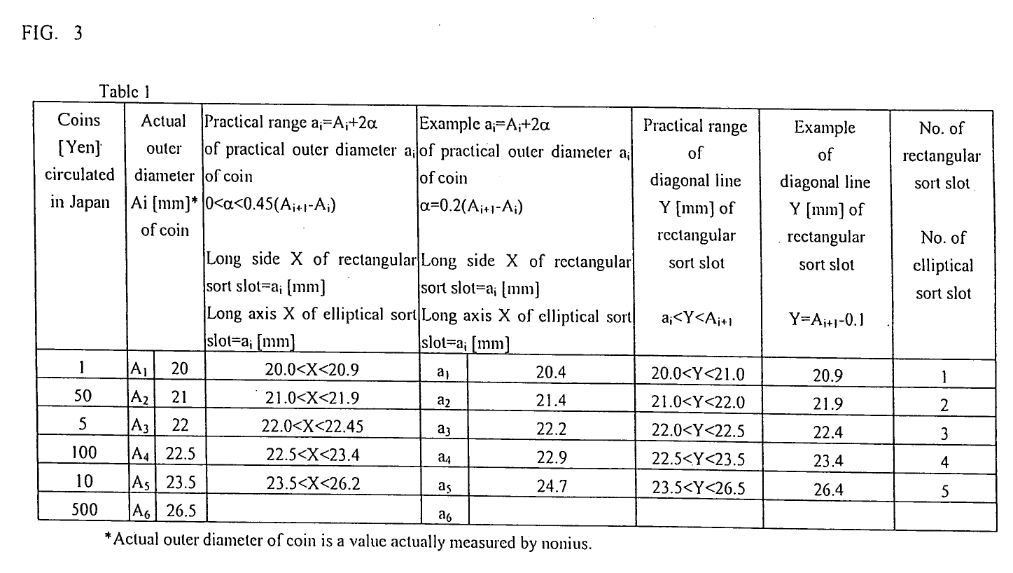

Shown in Table 1 of FIG. 3 are practical ranges and examples of actual outer diameters and practical outer diameters, and practical ranges and examples of various dimensions (X, Y, _{α}) of coin sort slots, concerning various coins circulated in Japan. Note that the play length _{α} is set such that _{α}=0.2(Aᵢ₊₁−Aᵢ), where the coin is made susceptible to pass through the associated sort slot.

In Japan, the actual outer diameters of coins are provided in an order of 1-yen<50-yen<5-yen<100-yen<10-yen<500-yen. In case of adoption of the rectangular sort slot of No. 4 sort slot in Table 1 of FIG. 3 as each upper coin sort slot 4 in FIG. 1, 500-yen coins and 10-yen coins can be blocked, and 100-yen coins, 5-yen coins, 50-yen coins, and 1-yen coins are allowed to pass therethrough. Further, in case of adoption of the rectangular sort slot of No. 2 sort slot in Table 1 of FIG. 3 as each lower coin sort slot 3, 100-yen coins and 5-yen coins can be blocked, and 50-yen coins and 1-yen coins are allowed to pass therethrough. As a result, the six kinds of a group of coins can be received and sorted into three groups.

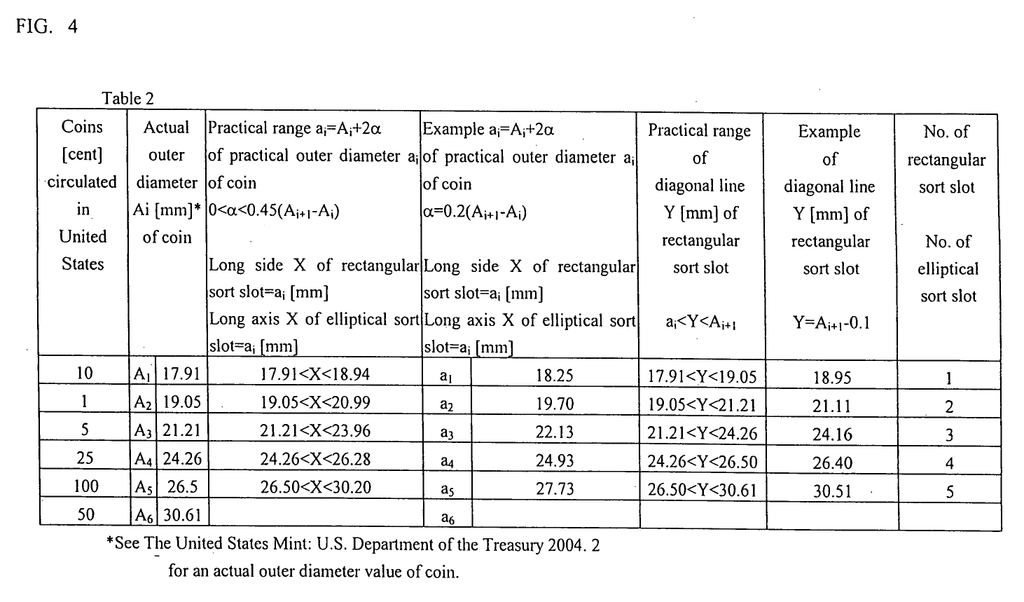

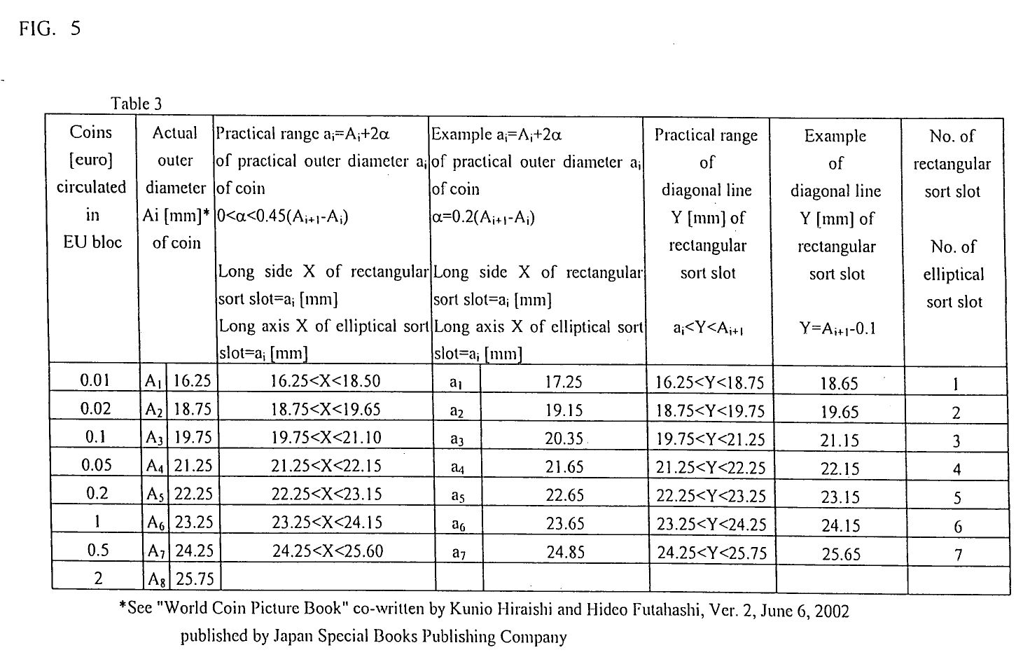

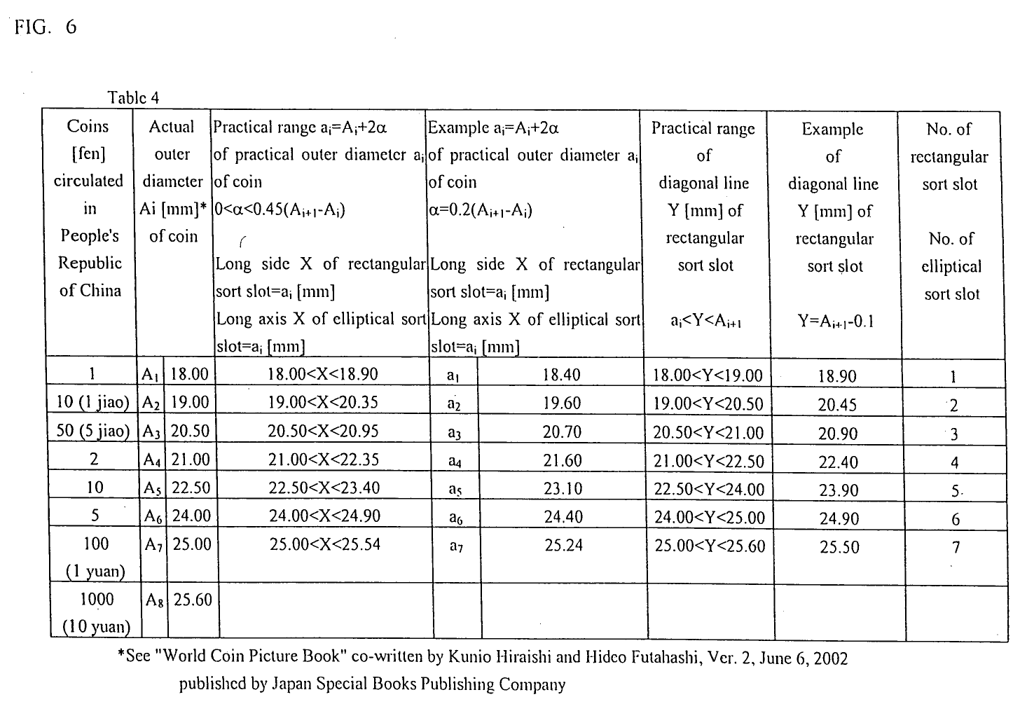

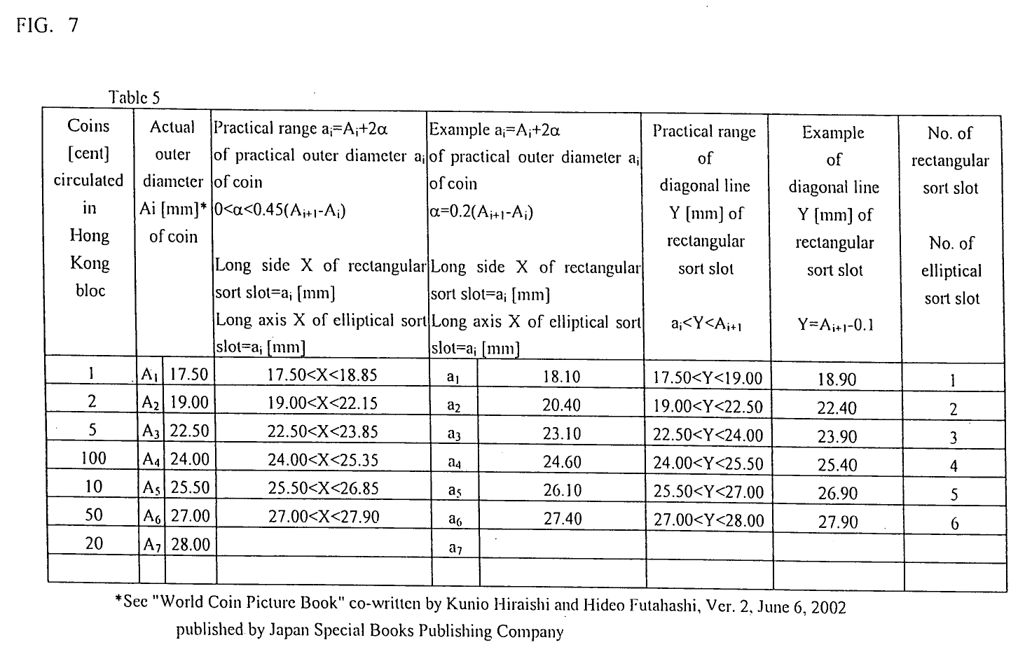

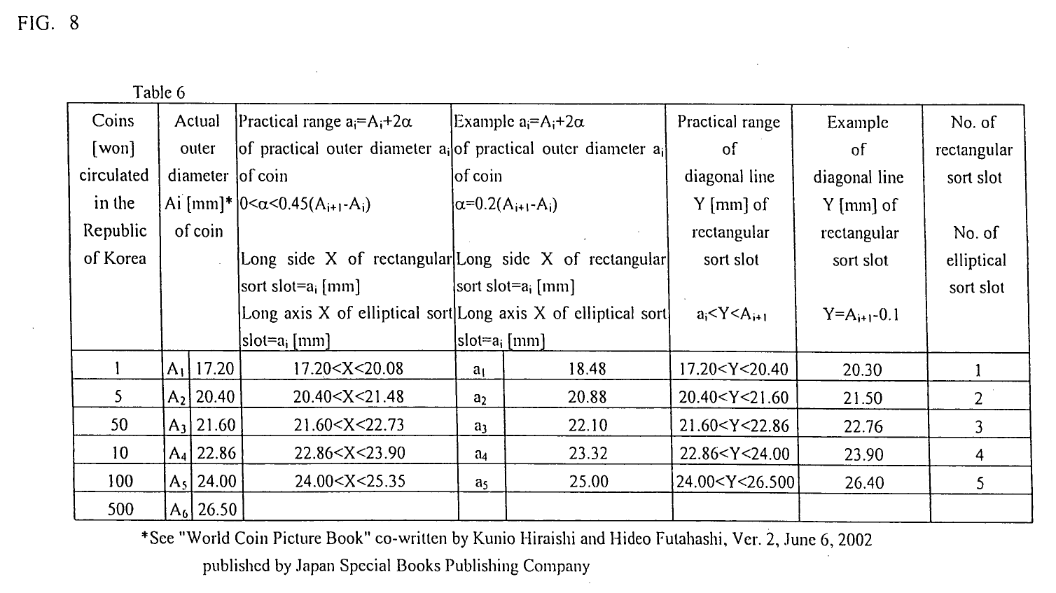

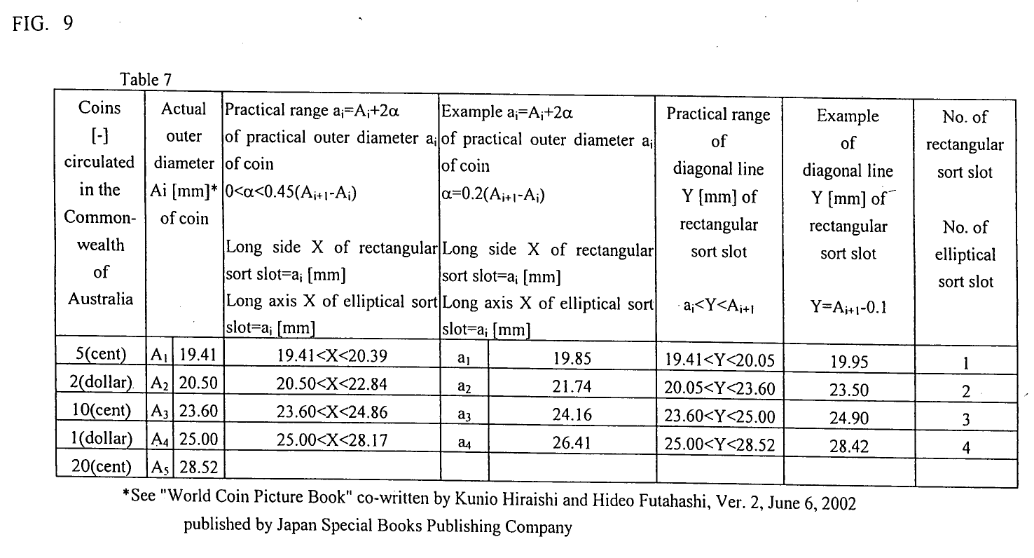

The currency sorting/cleaning case 101 of the present invention can also be applied to coins circulated in foreign countries other than Japan. In such a situation, the various dimensions (X, Y, _{α}) of the lower coin sort slots 3 and upper coin sort slots 4 are determined correspondingly to actual outer diameters of coins in the applicable country. As examples, Tables in FIG. 4 through FIG. 10 show practical ranges and examples of actual outer diameters and practical outer diameters, and practical ranges and examples of various dimensions (X, Y, _{α}) of coin sort slots, concerning various coins circulated in the United States, EU bloc, People's Republic of China, Hong Kong bloc, the Republic of Korea, the Commonwealth of Australia, and India, respectively.

As shown in FIG. 1, the coin sorting operation for vertically operating the coin receipt casing 6 simultaneously promotes the contact of the predetermined coin-oriented detergent with coins and movement of the former, and the operation for horizontally arranging the coin receipt casing 6 to open the coin takeout transparent opening/closing lid 2 for count and extraction of coins simultaneously serves as an operation for collecting the predetermined detergent into the detergent reservoir 7 and receiving it therein, so that the count and extraction of sterilized and cleaned coins can be substantially easily attained and repeated.

### OTHER EMBODIMENTS

Although coins have been sorted in the embodiment of FIG. 1 such that the rectangular sort slots of No. 2 and No. 4 of Table 1 shown in FIG. 3 have been adopted in numbers of six, respectively, in a two-staged manner, there will be particularly explained other embodiments where numerous coins are to be sorted and dealt with.

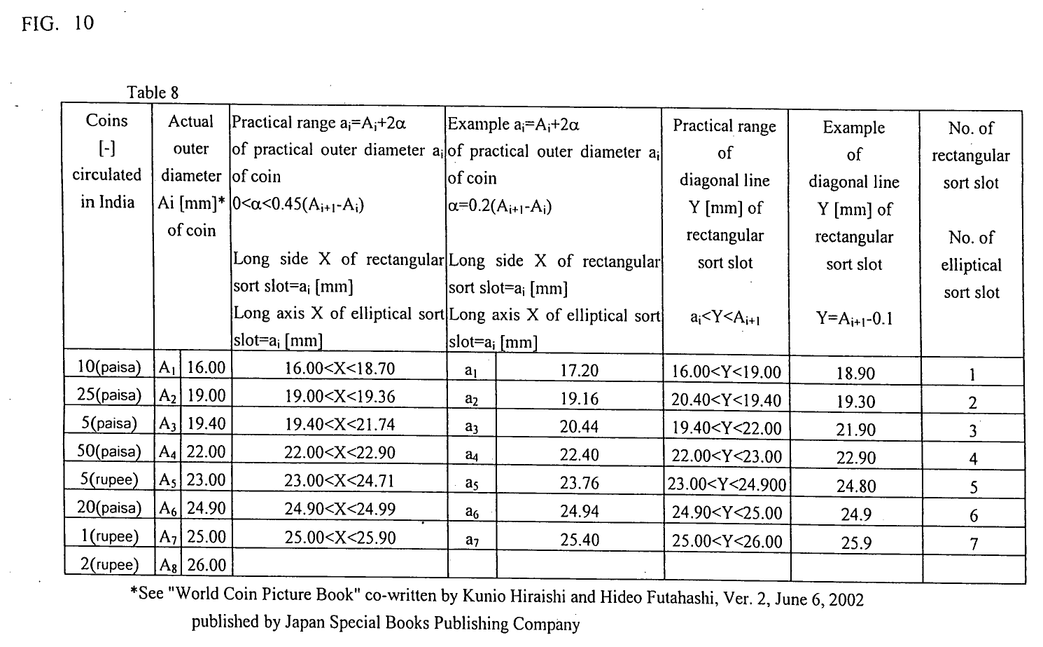

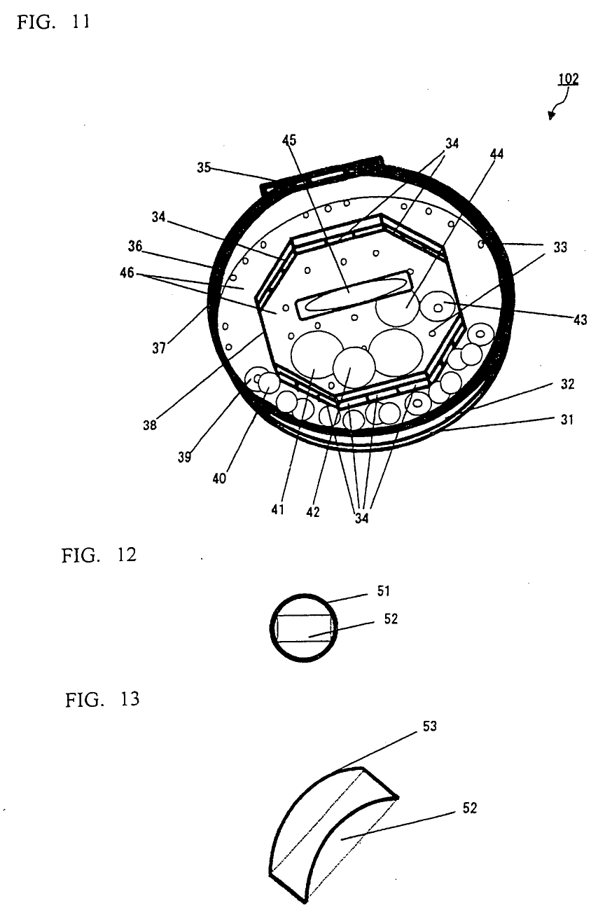

FIG. 11 shows a currency sorting/cleaning case 102 including an interior casing 38, and a large number of mutually coupled rectangular sort slots 34 of a single kind provided therethrough so as to provide a widened sort slot area for enhancing a contact possibility between the rectangular sort slots 34 and coins.

The sort slots 3, 4 used in the currency sorting/cleaning case 101 and the sort slots 34 used in the currency sorting/cleaning case 102 have been all rectangular. As other configurations of sort slots, it is conceivable to adopt: an elliptical sort slot(s) solely or in complex with; a sort slot in a shape embracing the rectangle of the above-described rectangular sort slot, such as a circular slot 51 embracing the inscribed rectangle 52 as shown in FIG. 12, or an arcuate side 53 sharing four apexes of the rectangle 52 as shown in FIG. 13; and all sort slots each embracing the rectangle 52 and exhibiting the same coin sorting function as the rectangle 52.

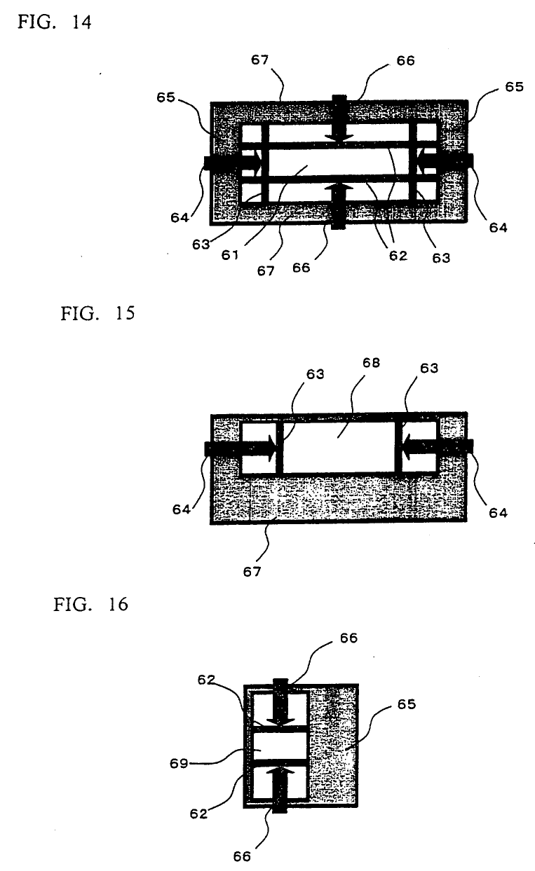

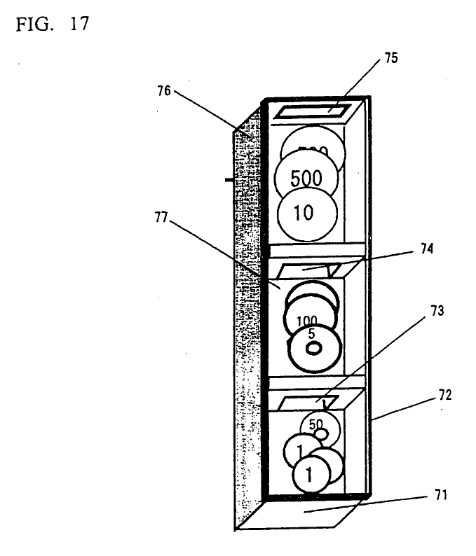

As still further configurations of sort slots, it is conceivable to adopt a rectangular sort slot including a rectangle having a long side and a short side the lengths of which can be arbitrarily adjusted. Such a sort slot will do as shown in FIG. 14, FIG. 15, and FIG. 16, having a rectangle defined by plates the lengths of which can be arbitrarily adjusted (this rectangular slot shall be called “adjustable rectangle sort slot” hereinafter).

FIG. 14 shows an adjustable rectangular sort slot 61, where four sides defining a rectangle are all movable in a manner that two pieces of long side shift plates 62 and two pieces of short side shift plates 63 are movable. The long side shift plates 62 are moved along long side shift plate guides 65 by adjusting long side adjustment screws 64, respectively. Similarly, the short side shift plates 63 are moved along short side adjustment screw guides 67 by adjusting short side adjustment screws 66, respectively. This enables the size of the adjustable rectangular sort slot 61 to be freely changed, within a predetermined range.

FIG. 15 is a plan view of the adjustable rectangular sort slot 61 viewed from the above. Provided at the above is a long side length measurement window portion 68 for facilitating length adjustment of the long side. FIG. 16 is a side view of the adjustable rectangular sort slot 61, viewed from the right. Provided in the right side view, is a short side length measurement window portion 69, for facilitating length adjustment of the short side.

Although the coin receipt casing 6 in the embodiment of FIG. 1 is in the shape combining a rectangular parallelepiped with a half-column here, the other embodiments are allowed to adopt configurations of casings depending on arranging manners of sort slots, such as exemplarily shown in FIG. 11 where numerous rectangular sort slots 34 are coupled and arranged in a polygonal shape. To an extent that the coin sorting and receiving function and the cleaning function of the present invention are not deteriorated, it is possible to adopt any configuration and material taking account of device design, handling, portability, and robustness.

For example, usable as materials of the casings and coin sort slots are hard resins such as PE, PP, PVC, ABS, PA, POM, PC, PBT, PET, PS, PPS and PMMA, and metals such as aluminum, aluminum alloy or magnesium alloy. Particularly, since materials of sort slots are required to have durability against mechanical impacts by coins to the associated rectangular slots or elliptical slots, those materials are effective which have higher hardness and strength levels such as WC—Co based or WC—TiC—Cr based superhard alloys, or Al—Zn—Mg based aluminum alloys.

Effectively usable as a seal material are various rubbers, particularly various TPE (thermoplastic elastomers) such as silicone rubber based or olefin based or nylon based ones, as materials for avoiding degradation and hardening and permanently keeping elasticity.

In the embodiment of FIG. 1, used as the predetermined detergent is a 30 vol % ethanol-water solution, at a volume of about 90% of that of the coin-oriented detergent reservoir 7. Further, usable as the predetermined detergent are: 75 to 82 vol % ethanol-water solution; undiluted ethanol; benzalkonium chloride ethanol solution including 100 ml of ethanol containing benzalkonium chloride therein; isopropanol; glycerin; glycerin-ethanol-water mixed solution; 0.02% to 0.5% solution of cationic or amphoteric surfactant; iodine based liquid such as povidone iodine containing 25 to 100 ppm of iodine; or a catechin water solution; as well as any other substances each having a sterilizing and cleaning effect for coins and fingers of a person and exhibiting flowability when received within the coin-oriented detergent reservoir 7.

Further, it is also possible to fix and install a sublimate antibacterial agent such as hinokitiol, parachlorometaxylenol, camphor, and the like at the casing bottom, lid portion, or the like of the device of the present invention, in a direct form or in a solidified diluted form by carrying the antibacterial agent on cellulose or on inorganic powder, such that the antibacterial gas itself or obtained by evaporating the antibacterial agent within the casing is caused to be adsorbed or attached to a surface of a coin or paper money, to thereby sterilize the coin or paper money.

It is further possible to commonly use such a sublimate antibacterial agent, as both of the predetermined detergent and additional predetermined detergent. Namely, it is possible to fix and install a single kind of sublimate antibacterial agent at a boundary site between the coin receipt casing 6 and paper money receipt casing 11 of the currency sorting/cleaning case 101 in FIG. 1, for example, to simultaneously introduce the same sublimate antibacterial gas into both the casings 6 and 11 without leakage to the exterior of the casings.

In order to simultaneously attain sterilization and cleaning of coins and fingertips without adverse effects on a human body and negative effects on the device of the present invention, and to give importance to retention of an antibacterial ability of coins and fingertips as hygienic media, it is possible to use, as the predetermined detergent or additional predetermined detergent, a water solution obtained by dissolving a complex composition substance derived from the following various functional agents in water.

Namely, it is possible to adopt a water solution obtained by appropriately dissolving such a composition in water, the composition being obtained by dissolving a functional material such as: tocopherol acetate, cetylpyridinium chloride, triclosan, 1,8-cineol, methyl salicylate, L-menthol, or the like, as a disinfectant; enzyme, limonene such as orange oil, coconut fatty acid amide propylbetaine liquid, pentasodium triphosphate, sodium lauryl sulfate, or the like, as a detergent; cyclodextrin, or the like, as an amplexus sustained-release agent; glycerin, sorbits as a wetting agent; methyl paraben, butyl paraben, benzoic acid, ethyl cocoyl arginine, or the like, as a preservative; aroma chemicals, saccharin sodium, or the like, as a flavoring agent; sodium citrate, sodium phosphate, as a pH regulator; or, persulfate, perborate, or the like as a bleaching agent; in ethanols as solvents, or in polyoxyethylene hardened castor oil, polyoxyethylene polyoxypropylene glycol, or the like, as a solubilizing agent, at an appropriate composition ratio.

Alternatively, it is possible to diffuse or dissolve a powder of such a composition in water to thereby generate hydrogen peroxide or oxygen, the composition being derived from a combination of carbonate, peroxocarbonate, surfactant, and organic chelate agent, for promoting and exhibiting antibacterial, bacteria eliminating, deodorizing, micro-organisms breaking, and cleaning abilities by virtue of activities of nascent oxygen.

Namely, it is possible to adopt: sodium carbonate, sodium bicarbonate, potassium carbonate, potassium bicarbonate, lithium carbonate, or the like, as the carbonate; sodium peroxo-monocarbonate, sodium peroxo-dicarbonate, potassium peroxo-monocarbonate, and potassium peroxo-dicarbonate, as the peroxocarbonate; surfactants containing a neutral surfactant such as polyoxyethylene glycol alkyl ether, polyethylene glycol fatty acid ester, sorbitan fatty acid ester, fatty acid mono glyceride, or the like; and, as the organic chelate agent, salts of polyaminocarboxylic acids such as ethylene diamine tetraacetate, glycine, _{α}-amino butyric acid, acetyl aminoacetic acid, leucine, alanine, glycylglycine, glutamic acid, 1-amino cyclohexane carboxylic acid, 2-amino cyclohexane hydrocarboxylic acid, or the like, salts of hydroxycarboxylic acids such as citric acid, glycolic acid, glyceric acid, lactic acid, malic acid, tartaric acid, or the like, and salts of various condensed phosphoric acids such as pyrophosphoric acid, triphosphoric acid, trimetaphosphoric acid, tetrametaphosphoric acid. It is also possible to use a dilute solution of sodium hypochlorite, potassium hypochlorite, and/or bleaching powder.

Moreover, usable as embodiments of the predetermined detergent or additional predetermined detergent of the present invention, are antibacterial inorganic powders obtained by adsorbing or ion-exchanging antibacterial metal ions to or with inorganic aluminosilicates, in a direct form, in a form dispersed in water, in a form dispersed in an organic matter, or in a form of three-component mixture of the antibacterial inorganic powder with gas and liquid as dispersion media. As a concrete example of the antibacterial aluminosilicates, it is possible to use: a zeolite antibacterial agent obtained by ion-exchanging sodium in a structure of natural or synthesized zeolite of a 4-angstrom type by silver ion; in a powder form or any one of various liquid slurry forms.

Furthermore, in such a clean situation of coins where the coins have been already cleaned by the above described cleaning disinfectant, or where the sublimate solid antibacterial agent is used by installing it within the device, it is possible to adopt such a coin sort case 103 having only the coin sorting and receiving functions of the present invention as shown in FIG. 11 in a manner to provide it by excluding the cleaning equipment from the above currency sorting/cleaning case. The coin sort case 103 has a lower coin sort slot 73 corresponding to that of No. 2 and an upper coin sort slot 74 corresponding to that of No. 4 in Table 1 shown in FIG. 3, so that various coins charged through an opening/closing type coin charge opening 75 are sorted while downwardly moving along a coin movement floor 77.

There will be explained experimental results where coins were sorted and cleaned by the currency sorting/cleaning case of the present invention. In the currency sorting/cleaning case 101 of FIG. 1, used as materials of the sort slots 3, 4 were an Al—Mn based alloy at an aluminum purity of 96.85%, while setting the play length such that _{α}=0.2{[Aᵢ₊₁]−[Aᵢ]} and adopting those of No. 2 and No. 4 of Table 1 shown in FIG. 3 as the sizes of the sort slots 3, 4, respectively. Namely, each sort slot 3 had a long axis X of 21.4 mm and a diagonal line Y of 21.9 mm, and each sort slot 4 had a long axis X of 22.9 mm and a diagonal line Y of 23.4 mm.

There was set a standard coin group [two 500-yen coins, four 10-yen coins, three 100-yen coins, four 5-yen coins, three 50-yen coins, and six 1-yen coins], and the coins were charged into the currency sorting/cleaning case 101 of FIG. 1, followed by vertical mounting thereof to a predetermined shaking machine, and by vertical shaking thereof at 60 cycle/min. There was observed a coin sorted state every ten seconds to thereby measure a sort completion time, resulting in a sort completion shown in FIG. 1 in 20 seconds.

For comparison with the coin sorting performance by the currency sorting/cleaning case 101 of the present invention, the play length was set so that _{α}=0, each sort slot 3 was set to have a long axis X of 21.0 mm (actual outer diameter of 50-yen coin), and each sort slot 4 was set to have a long axis X of 22.5 mm (actual outer diameter of 100-yen coin), and the remaining conditions were all equalized to those of the currency sorting/cleaning case 101 of the present invention. There was measured a sort completion time of the standard coin group, and 40 minutes were required to complete the sortation such as shown in FIG. 1. In the situation where the play length _{α}=0, there were observed more repelling opportunities by the sort slots 3, 4 against coins than by the currency sorting/cleaning case 101 of the present invention.

There will be explained a result of a confirmed coin cleaning effect by the currency sorting/cleaning case 101 of the present invention. The coin-oriented detergent reservoir 7 of the currency sorting/cleaning case 101 shown in FIG. 1 was filled, at a 90 vol % thereof, with a cleaning disinfectant liquid as the predetermined detergent, obtained by dissolving 0.1 g of benzalkonium chloride in 100 ml of 30% ethanol water solution, and the standard coin group was charged through the opening/closing type coin charge opening 9 and shaken at a speed of 60 cycle/min for 0.5 hr. The four 1-yen coins of the standard coin group were measured with reference to the antibacterial testing method JISZ2801, section 5.2, and growth of live bacteria was not recognized.

Again for comparison, without introducing any cleaning disinfectant liquids into the coin-oriented detergent reservoir 7, the standard coin group was charged into the currency sorting/cleaning case 101 of FIG. 1, and shaken at a speed of 60 cycle/min for 0.5 hr. The four 1-yen coins were measured with reference to the antibacterial testing method JISZ2801, section 5.2, and growth of live bacteria was recognized (the counted number of live bacteria: 270).

Note that the antibacterial test with reference to the JISZ2801, section 5.2 was performed as follows. Four 1-yen aluminum coins as test pieces were introduced into a petri dish, and each test piece was covered at its upper surface with a film exhibiting no antibacterial effects. It was stored for 24 hours at 35° C. and at 90% RH or higher, then one sides of the test pieces were cleaned up by a liquid, the liquid after cleaning was cultured on an agar medium, and the number of live bacteria was counted.

1. A currency sorting/cleaning case, comprising:
a coin receipt casing configured to define a space for receiving coins therein;
a coin movement floor constituting a part of said coin receipt casing to cause the coins to move horizontally;
a coin sort slot provided within said coin receipt casing and having a slot in a predetermined size to sort coins;
a detergent reservoir provided adjacently to said coin receipt casing, said detergent reservoir being configured to reserve therein a detergent for cleaning coins;
a detergent hole provided at a boundary between said coin receipt casing and said detergent reservoir such that the detergent comes out of said detergent reservoir into said coin receipt casing and comes back therefrom into said detergent reservoir;
an opening/closing type charge opening provided at a part of said coin receipt casing and configured to charge coins through said opening/closing type charge opening itself;
an opening/closing lid provided at a part of said coin receipt casing, said opening/closing lid being configured to cause coins to be taken out of said coin receipt casing; and
a seal portion configured to prevent the detergent from leaking through a gap between said opening/closing lid and said casing.

2. The currency sorting/cleaning case of claim 1, wherein said opening/closing lid is transparent or translucent, and
wherein said currency sorting/cleaning case further comprises:
an anchor configured to closely contact and fix said opening/closing lid with and to said seal portion;
a paper money receipt casing provided to be coupled to said coin receipt casing, said paper money receipt casing being configured to receive paper moneys therein;
a paper money arrangement floor provided within said paper money receipt casing, said paper money arrangement floor being configured to arrange paper moneys with height differences therebetween in a stepwise manner;
an additional detergent reservoir provided adjacently to said paper money receipt casing, said additional detergent reservoir being configured to reserve an additional detergent therein;
an additional opening/closing lid provided at a part of said paper money receipt casing, said additional opening/closing lid being configured to allow charge and withdrawal of paper moneys therethrough;
an additional seal portion configured to prevent leakage of said additional detergent from a gap between said additional opening/closing lid and said paper money receipt casing; and
an additional anchor configured to closely contact and fix said additional opening/closing lid with and to said additional seal portion.

3. The currency sorting/cleaning case of claim 1, wherein said coin movement floor is a flat and smooth plate forming a bottom surface of said coin receipt casing.

4. The currency sorting/cleaning case of claim 1, wherein said detergent hole is provided on said coin movement floor;
wherein said detergent reservoir is arranged parallel to the bottom surface of said coin receipt casing;
wherein the detergent flows from said detergent reservoir through said detergent hole into said coin receipt casing; and
wherein the detergent is collected back from said coin receipt casing through said detergent hole into said detergent reservoir and received therein.

5. The currency sorting/cleaning case of claim 1, wherein said slot provided in said coin sort slot is in a rectangular shape or in a shape containing the rectangular shape, or is in an elliptical shape or in a shape containing the elliptical shape.

6. The currency sorting/cleaning case of claim 5, wherein said slot of said coin sort slot has a shape formed to allow passage therethrough of a coin in a predetermined size and a coin smaller than it, and to prevent passage therethrough of a coin larger than the coin in the predetermined size, and
wherein assuming that the coin in the predetermined size has a diameter Aᵢ, a coin which is next larger than the coin in the predetermined size has a diameter Aᵢ₊₁, and a play length α is defined such that 0<_{α}<0.45(Aᵢ₊₁−Aᵢ),
the shape of said slot of said coin sort slot is a rectangular shape having a long side length equal to Aᵢ+2α and a diagonal line length smaller than Aᵢ₊₁, or an elliptical shape having a long axis length equal to Aᵢ+2α.

7. The currency sorting/cleaning case of claim 1, wherein said coin sort slot has a peripheral frame partially contacted with said coin movement floor;
wherein said coin sort slot comprises multiple coin sort slots installed in a decreasing order of sort slot size when viewed from said opening/closing type charge opening; and
wherein said coin movement floor and frames of said coin sort slots cooperatively define sort receipt regions for receiving therein sorted coins, respectively.

8. The currency sorting/cleaning case of claim 2, wherein said paper money arrangement floor is arranged at a predetermined inclination angle relative to mutually parallel bottom surface and upper surface of said paper money receipt casing, in a manner that only an upper side of said paper money arrangement floor is contacted with said bottom surface and that said paper money arrangement floor is arranged perpendicularly to sidewalls of said paper money receipt casing which are perpendicular to said bottom surface and said upper surface.

9. The currency sorting/cleaning case of claim 2, wherein said additional detergent reservoir is arranged adjacently to a wall surface within said paper money receipt casing or to said paper money arrangement floor; and
wherein said additional detergent is flowed into said paper money receipt casing through an additional detergent hole provided at said wall surface of said paper money receipt casing and/or said paper money arrangement floor.

10. The currency sorting/cleaning case of claim 1, wherein said detergent and said additional detergent are each liquid, solid, and/or gas having a currency cleaning effect.

11. The currency sorting/cleaning case of claim 1, wherein said coin receipt casing and said paper money receipt casing have sidewalls formed with taper-type female ventilation holes, respectively;
wherein said coin receipt casing and said paper money receipt casing are equipped with at least one or more of said anchor and said additional anchor, respectively; and
wherein said anchor and said additional anchor are provided with pins, which have tip ends to be closely contacted with said taper-type female ventilation holes, respectively, and which each close said taper-type female ventilation hole when said opening/closing lid or said additional opening/closing lid is closed and each opens said taper-type female ventilation hole when said opening/closing lid or said additional opening/closing lid is opened.

12. The currency sorting/cleaning case of claim 5, wherein,
assuming that diameters of a group of coins circulated within a single economic bloc having “n” kinds of diameters A₁, A₂, A₃, . . . Aᵢ, Aᵢ₊₁, . . . Aₙ (mm) are defined as actual outer diameters, respectively,
that the actual outer diameters are in an order of:
A₁<A₂<A₃< . . . Aᵢ<Aᵢ₊₁< . . . <Aₙ; and
that outer diameters, which are obtained by adding a play length α mm to both ends of the actual outer diameters in rectilinear directions thereof, are defined as practical outer diameters a₁, a₂, a₃, . . . aᵢ, aᵢ₊₁, . . . aₙ (mm), respectively,
i.e.,
a₁=A₁+2α
a₂=A₂+2α
. . .
. . .
aᵢ=Aᵢ+2α
aᵢ₊₁=Aᵢ₊₁+2α
. . .
. . .
aₙ=Aₙ+2α;
where “n” is a natural number, and “i” is an integer from 1 to “n”;
the rectangle and/or ellipse constituting the shape of said coin sort slot is a rectangle and/or an ellipse,
in which the rectangle has the play length α, long axis X, and diagonal line Y, represented by:
0<α<0.45(Aᵢ₊₁−Aᵢ),
X=aᵢ, and aᵢ<Y<Aᵢ₊₁, respectively; and
in which the ellipse has the long axis X represented by:
X=aᵢ.

13. The currency sorting/cleaning case of claim 2, wherein said detergent and said additional detergent are each liquid, solid, and/or gas having a currency cleaning effect.

14. The currency sorting/cleaning case of claim 2, wherein said coin receipt casing and said paper money receipt casing have sidewalls formed with taper-type female ventilation holes, respectively;
wherein said coin receipt casing and said paper money receipt casing are equipped with at least one or more of said anchor and said additional anchor, respectively; and
wherein said anchor and said additional anchor are provided with pins, which have tip ends to be closely contacted with said taper-type female ventilation holes, respectively, and which each close said taper-type female ventilation hole when said opening/closing lid or said additional opening/closing lid is closed and each opens said taper-type female ventilation hole when sa d opening/closing lid or said additional opening/closing lid is opened.
